(19) United States
(12) Patent Application Publication
(10) Pub. No.: US 2026/0125164 A1
(43) Pub. Date: May 7, 2026

(54) METHOD FOR OPERATING AN ASSEMBLY SYSTEM

(71) Applicant: Broetje-Automation GmbH, Rastede (DE)

(72) Inventor: Christian Heyers, Edewecht (DE)

(21) Appl. No.: 19/380,300

(22) Filed: Nov. 5, 2025

Related U.S. Application Data
(60) Provisional application No. 63/717,178, filed on Nov. 6, 2024.

(51) Int. Cl. B64F 5/10

(52) U.S. Cl. CPC B64F 5/10

(57) ABSTRACT

A method for operating an assembly system for assembling a structural component, in particular an aircraft structural component, the assembly system comprising an assembly management system for the management of assembly tasks in at least one assembly station, the at least one assembly station comprising a structural component holder for holding the structural component, the assembly system, in particular the assembly station, comprises at least one guide system comprising a light projector for guiding an operator via projections, wherein at least the projection data of at least two projections for different assembly steps is transferred to the guide system together and/or the projection data for at least one projection including shape and location information for that projection is transferred to the guide system together.

### RELATED APPLICATIONS

This application claims the benefit of U.S. Provisional Application No. 63/717,178, filed Nov. 6, 2024, the content of which is incorporated herein by reference in its entirety.

### FIELD OF THE TECHNOLOGY

Various embodiments relate to a method for operating an assembly system and to an assembly system for assembling a structural component.

### SUMMARY

It is known to use a guide device with a projector in order to guide an operator in the manufacturing of fiber composite components, in particular aircraft structural components. These projectors indicate how fiber mats are to be placed layer by layer.

Furthermore, it is known to assemble structural components in assembly stations and to assist the operator by illustrating the assembly tasks to be performed. However, it has been found, that the assembly time as well as the assembly quality may be improved.

It is a challenge to improve on the known prior art.

Various embodiments are based on the problem of improving current methods such that a further optimization regarding the named challenge is reached.

The above-noted object is solved by various features provided herein.

A realization of various embodiments is that at least one guide system is used comprising a light projector for guiding an operator via projections and wherein at least the projection data of at least two projections for different assembly steps is transferred to the guide system together and/or the projection data for at least one projection including shape and location information for that projection is transferred to the guide system together.

This enables a simple and efficient way to guide the worker through the assembly tasks and improve assembly time and quality. Additionally or alternatively an efficient way to transfer the projection data is provided in order to facilitate the guidance of the operator and ensure simple transfer of the projection data and quick response times of the guide systems.

The transfer in one file as proposed in various embodiments enables an easy handling and transfer of the data.

Various embodiments facilitate the easy handling and transfer of the data further.

The transformation according to some embodiments enables an improved projection quality.

Various embodiments enable simple and/or efficient data transfer.

Various embodiments provide projection quality of the guide system and enables the verification of assembled assembly parts.

Various embodiments allow to support the operator in his assembly tasks.

Various embodiments enable an easy and efficient way to supply assembly parts to the assembly station for assembling them to the structural component and/or to support an accurate assembly of the assembly parts.

Various embodiments improve quality of structural components and enable to give close feedback to the operator.

Various embodiments provide an easy and efficient way for the operator to confirm installation of the assembly part.

Various embodiments provide improve the assembly management and track the assembly process.

Various embodiments provide projection and verification quality of the guide system.

Various embodiments relate to an assembly system for assembling a structural component, in particular an aircraft structural component, the assembly system comprising an assembly management system for the management of assembly tasks in at least one assembly station, the at least one assembly station comprising a structural component holder for holding the structural component, in particular via a clamping frame, the assembly system, in particular the assembly station, comprises at least one guide system comprising a light projector for guiding an operator via projections, the assembly system designed for carrying out the method as provided herein.

This enables a simple and efficient way to guide the worker through the assembly tasks end improve assembly time and quality. Additionally or alternatively, an efficient way to transfer the projection data is provided in order to facilitate the guidance of the operator and ensure simple transfer of the projection data and quick response times of the guide systems.

Various embodiments provide a method for operating an assembly system for assembling a structural component, in particular an aircraft structural component, the assembly system comprising an assembly management system for the management of assembly tasks in at least one assembly station, the at least one assembly station comprising a structural component holder for holding the structural component, the assembly system, in particular the assembly station, comprises at least one guide system comprising at least one light projector for guiding an operator via projections,

wherein at least the projection data of at least two projections for different assembly steps is transferred to the guide system together and/or the projection data for at least one projection including shape and location information for that projection is transferred to the guide system together.

In various embodiments, at least the projection data of at least two projections for different assembly steps are transferred to the guide system together in one file and/or the projection data for at least one projection including shape and location information for that projection is transferred to the guide system together in one file.

In various embodiments, the projection data of the majority, in particular all, projections for the assembly steps of one structural component are transferred to the guide system together, in particular in one file.

In various embodiments, the projection data has been transformed such, that it takes the projection surface on which the projections are projected and/or the shape of the structural component after the assembly step to be supported by the projection into account.

In various embodiments, the projection data of a projection defines the projection as a plurality of coordinates and/or pixels.

In various embodiments, the guide system comprises a sensor, in particular for an adjustment step of the structural component and the guide system and/or for a verification step for verification of the assembly of an assembly part to the structural component.

In various embodiments, the assembly management system generates an instruction set for guiding an operator, wherein the instruction set comprises a plurality of, in particular sequential, assembly tasks, and/or, that in the assembly management system the individual assembly tasks of an instruction set are linked to individual projections.

In various embodiments, the assembly system, in particular the assembly station, comprises at least one supply arrangement for supplying assembly parts to the assembly station. In some embodiments, the supply arrangement comprises a supply tray carrying at least on assembly part, in particular a rivet or a stringer.

In various embodiments, the supply arrangement comprises a supply control for operation of the supply arrangement and/or an optical sensor, in particular a vision sensor and/or a photo eye sensor.

In various embodiments, the guide system and/or a supply projector indicates the assembly part to pick for assembly with a projection onto the assembly part and/or the supply tray.

In various embodiments, the optical sensor, in particular the vision sensor, acquires an image of the supply tray prior the assembly part to be assembled is taken from it and after the assembly part to be assembled is taken from it. In some embodiments, the images can be compared in order to analyze if the right part has been taken from the supply tray.

In various embodiments, the optical sensor, in particular a photo eye sensor, detects the entering of the hand of an operator and/or the removal of a hand of an operator from the supply tray.

In various embodiments, the guide system projects the outline of the assembly part onto the structural component on the position where it is to be installed.

In various embodiments, the operator waves a reflective card after installation of the assembly part, in particular the operator waves the reflective card between the projection and the projector.

In various embodiments, a verification step is performed and a section of the structural component, on which the assembly part was installed, is scanned and compared to control data, in particular the verification step is performed on detection of the waving of the reflective card by the projector.

In various embodiments, the guide system reports to the assembly management system, whether the verification step was successful or not.

In various embodiments, the guide system performs a scan of the structural component and/or the structural component holder in order to assess the orientation of the structural component to the projector in an adjustment step. In some embodiments, the guide system performs a transformation the projection data based on the result of the adjustment step in order to align projection and structural component.

Various embodiments provide an assembly system for assembling a structural component, in particular an aircraft structural component, the assembly system comprising an assembly management system for the management of assembly tasks in at least one assembly station, the at least one assembly station comprising a structural component holder for holding the structural component, in particular via a clamping frame, the assembly system, in particular the assembly station, comprises at least one guide system comprising a light projector for guiding an operator via projections, the assembly system designed for carrying out the method as provided herein.

All explanations given with regard to the method are fully applicable.

### BRIEF DESCRIPTION OF THE DRAWINGS

In the following, various embodiments are explained with respect to the drawing. The drawing shows in

FIG. 1 in a) an embodiment of an assembly station of an assembly system for assembling a structural component according to various embodiments in a front view and in b) in a top view,

FIG. 2 in a) the assembly management system, a guide system and a supply arrangement of an embodiment of an assembly system according to various embodiments and in b) an embodiment of the guide system projecting a projection on a structural component,

FIG. 3 an embodiment of the supply arrangement and assembly parts to be installed and

FIG. 4 in a) the process of guiding an operator to pick and remove an assembly part from the supply tray and in b) the process of installation and verification of the installation supported by the guide system.

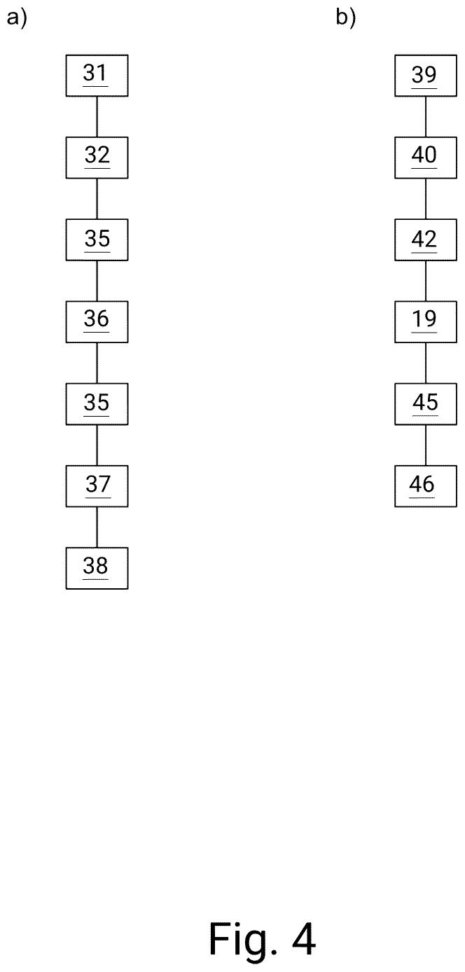

### DETAILED DESCRIPTION

The figures show an assembly system 1 for assembling a structural component 2, in particular an aircraft structural component 2 and a method for operating it.

The assembly system 1 is for assembling a structural component 2, in particular an aircraft structural component 2. The aircraft structural component 2 in various embodiments is a fuselage component of an aircraft.

The assembly system 1 comprises an assembly management system 3 and at least one assembly station 4. The assembly management system 3 is for the management of assembly tasks 5 in at least one assembly station 4.

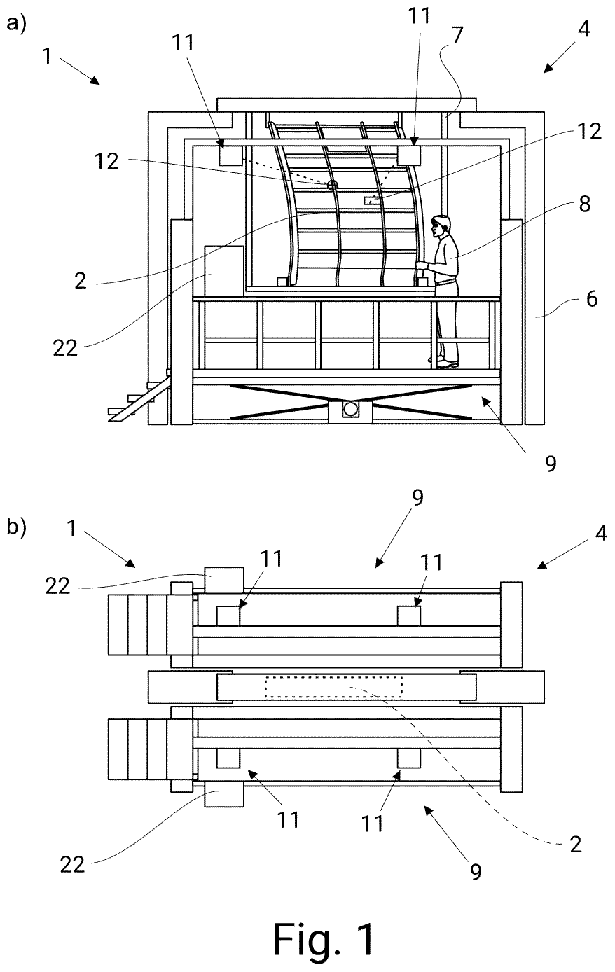

The at least one assembly station 4, which is shown in FIG. 1, comprises a structural component holder 6 for holding the structural component 2. In various embodiments, the structural component 2 is mounted in a clamping frame 7. The clamping frame 7 can be mounted in the structural component holder 6. Thus, for example, the structural component 2 may be hold directly by the structural component holder 6 or via a clamping frame 7. The structural component 2 is here held in a vertical orientation. This enables a good accessibility for the operator 8 from both sides.

In FIG. 1 the structural component 2 is mounted in a clamping frame 7. By this, it can be transported and stored in a simple manner. In various embodiments, the structural component 2 is delivered to the assembly station 4 and mounted into the structural component holder 6 in the clamping frame 7. In various embodiments, this is coordinated by the assembly management system 3.

In various embodiments, the assembly station 4 may comprise a lifting platform 9. In the embodiment of FIG. 1 there are two, as is illustrated in the top view of FIG. 1b). The lifting platform 9 allows the operator 8 to reach different sections of the structural component 2 during assembly.

The assembly system 1 further comprises at least one guide system 10 comprising at least one light projector 11 for guiding an operator 8 via projections 12. In the embodiment of FIG. 1 it is the assembly station 4 comprising the guide system 10. In the embodiment of FIG. 1 four light projectors 11 are shown. Here the light projectors 11 are laser light projectors 11, in particular the projecting light has basically one wavelength.

The guide system 10 is capable of guiding an operator 8 through assembly tasks 5. The projections 12 indicate to the operator 8 which assembly part 13 to be picked and assembled next and/or the position and orientation of the assembly part 13 on the structural component 2. These projections 12 can be projected in a sequential manner and/or enable an efficient and accurate assembly process as well as reduces defects.

Proposed is that at least the projection data 14 of at least two projections 12 for different assembly steps is transferred to the guide system 10 together and/or the projection data 14 for at least one projection 12 including shape and location information for that projection 12 is transferred to the guide system 10 together.

This enables a simple and efficient way to guide the worker through the assembly tasks 5 and improve assembly time and quality. Additionally or alternatively, an efficient way to transfer the projection data 14 is provided in order to facilitate the guidance of the operator 8 and ensure simple transfer of the projection data 14 and quick response times of the guide systems 10.

In various embodiments, the projection data 14 is transferred after the structural component 2 respectively the clamping frame 7 is mounted to the structural component holder 6.

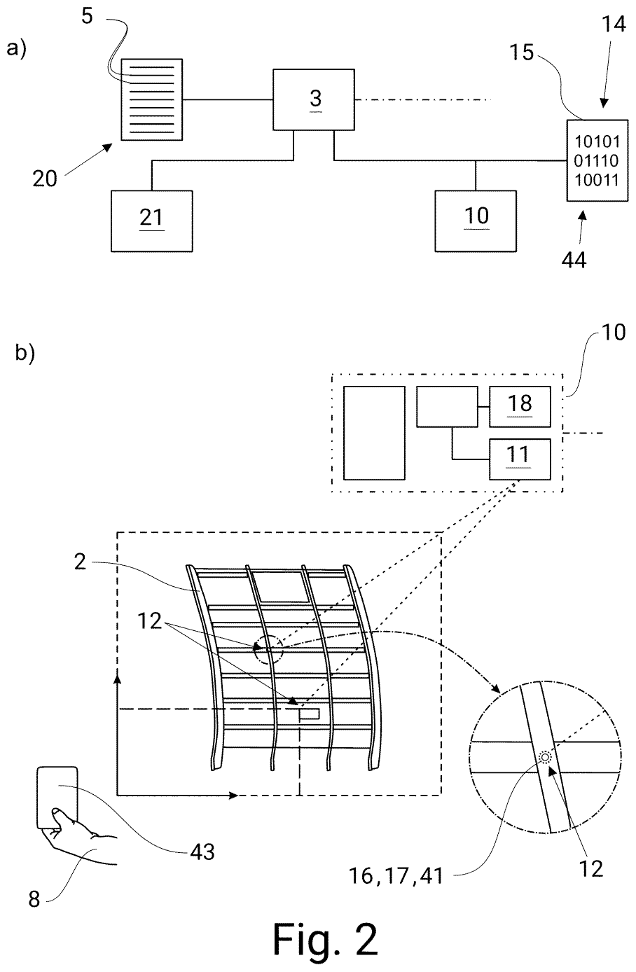

In various embodiments, the projection data 14 is transferred from the assembly system 1 to the guide system 10 as illustrated in FIG. 2a). It can contain shape and location information of the projections 12 respectively the at least one projection 12.

According to various embodiments, it is proposed that at least the projection data 14 of at least two projections 12 for different assembly steps are transferred to the guide system 10 together in one file 15 and/or the projection data 14 for at least one projection 12 including shape and location information for that projection 12 is transferred to the guide system 10 together in one file 15. The one file 15 is, in some embodiments, an XML. In this case the file contains XML structured data.

According to one embodiment it is proposed that the projection data 14 of the majority, in particular all, projections 12 for the assembly steps of one structural component 2 are transferred to the guide system 10 together, in particular in the one file 15. This allows easy data handling and linkage on the side of the assembly management system 3 as well as the guide system 10.

According to one embodiment it is proposed that the projection data 14 has been transformed such, that it takes into account the projection 12 surface on which the projections 12 are projected and/or the shape of the structural component 2 after the assembly step to be supported by the projection 12. This is of particular advantage if the structural component 2 comprises uneven, in particular convex and/or concave, surfaces. The transformed projection data 14 allows a proper, in particular undistorted projection 12 appearance on the structural component 2.

In various embodiments, the projection data 14 is already stored in the assembly management system 3 in a transformed manner and transferred to the guide system 10 in this transformed manner. The projection data 14 can be stored in a memory of the assembly management system 3 and on a memory of the guide system 10 during assembly. The already transformed projection data 14 may be generated based on CAD data of the structural component 2.

According to one embodiment it is proposed that the projection data 14 of a projection 12 defines the projection 12 as a plurality of coordinates 16 and/or pixels 17. In the example embodiment the pixel 17 map on which basis the pixels 17 are defined covers a view from the at least one projector on essentially the whole structural component 2, as it is illustrated in FIG. 2b). In various embodiments, the projection 12 is defined in a positive manner in the projection data 14. In particular the projection data 14 contains for each projection 12 the pixels 17 and/or coordinates 16 to be illuminated. In various embodiments, the coordinates 16 and/or pixels 17 not to be illuminated are omitted in the projection data 14 of a projection 12.

In various embodiments, the guide system 10 comprises a sensor 18, in particular for an adjustment step of the structural component 2 and the guide system 10 and/or for a verification step 19 for verification of the assembly of an assembly part 13 to the structural component 2.

With the combination of the light projector 11 and the sensor 18 it is possible to adjust the orientation of the workpiece towards the light projector 11 and/or to verify if the assembly of an assembly part 13 to the structural component 2 is ok. In various embodiments, Time-of-Flight-Measurements are used for adjustment and/or verification by the guide system 10.

In various embodiments, the projection data 14 and/or the file 15 is transferred prior the first assembly step at the assembly station 4. The file 15 may comprise adjustment data enabling to perform an adjustment step.

Further, in some embodiments, the adjustment step has been conducted prior the assembly of the first assembly part 13 at the assembly station 4.

According to one embodiment it is proposed that the assembly management system 3 generates an instruction set 20 for guiding an operator 8, wherein the instruction set 20 comprises a plurality of, in particular sequential, assembly tasks 5.

Further, in various embodiments, in the assembly management system 3 the individual assembly tasks 5 of an instruction set 20 are linked to individual projections 12. These can be defined in the file 15 transferred.

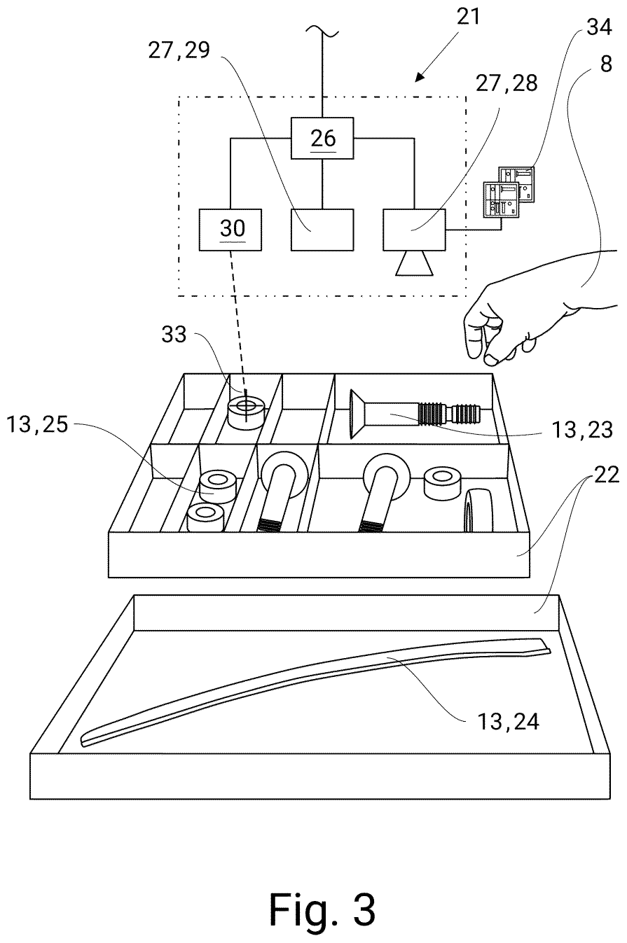

According to one embodiment it is proposed that the assembly system 1, in particular the assembly station 4, comprises at least one supply arrangement 21 for supplying assembly parts 13 to the assembly station 4, in various embodiments, the supply arrangement 21 comprises a supply tray 22 carrying at least one assembly part 13, in particular a rivet 23 and/or a stringer 24 and/or a collar 25. This is illustrated in FIG. 3. In various embodiments, with this method rivets 23 and/or collars 25 and/or stringers 24 are installed on the structural component 2 in the assembly station 4.

According to one embodiment it is proposed that the supply arrangement 21 comprises a supply control 26 for operation of the supply arrangement 21 and/or an optical sensor 27, in particular a vision sensor 28 and/or a photo eye sensor 29. Additionally, the supply arrangement 21 may comprise a supply projector 30.

According to one embodiment it is proposed that the guide system 10 and/or a supply projector 30 indicates the assembly part 13 to pick for assembly with a projection 12 onto the assembly part 13 and/or the supply tray 22.

When an assembly part 13 from the supply tray 22 is to be installed on the structural component 2, the assembly management system 3 sends coordinates 16 of the part to be installed to the supply arrangement 21 and/or the guide system 10 (instruction for assembly part removal 31). The supply projector 30 and/or the light projector 11 mark the part to be picked and installed with a projection 12 (marking step 32). In FIG. 3 this is illustrated with a projected crosshair 33.

According to one embodiment it is proposed that the guide system 10 and/or a supply projector 30 indicates the assembly part 13 to pick for assembly with a projection 12 onto the assembly part 13 and/or the supply tray 22.

According to one embodiment it is proposed that the optical sensor 27, in particular the vision sensor 28, acquires an image 34 of the supply tray 22 prior the assembly part 13 to be assembled is taken from it and/or after the assembly part 13 to be assembled is taken from it. Afterwards the images 34 are compared in order to analyze if the right part has been taken from the supply tray 22. By this approach, it can be controlled if the right assembly part 13 has been taken and/or the place to assemble the taken assembly part 13 is marked by the projection 12.

In various embodiments, the supply arrangement 21 compares the color score of the images 34 in the area in which the assembly parts 13 are located. By comparing the color scores it can assess which respectively if the right assembly part 13 has been taken. In the example it is assumed the assembly part 13 has been taken if the color score delta of the image 34 is equal or higher 30%.

In various embodiments, an image 34 is acquired by the vision sensor 28 from the supply tray 22 after the marking step 32 (image acquisition 35). The operator 8 grabs the marked assembly part 13 and removes it from the tray (assembly part removal 36).

According to one embodiment it is proposed that the optical sensor 27, in particular a photo eye sensor 29, detects the entering of the hand of an operator 8 and/or the removal of a hand of an operator 8 from the supply tray 22. This is an easy way to detect the pick up respectively taking and removal of an assembly part 13 from the supply tray 22 (detection of assembly part removal 36).

In various embodiments, the photo eye sensor 29 detects that the operator 8 has removed his hand from the area where the taken assembly part 13 has been. Upon detection of the removal a second image 34 is acquired (image acquisition 35). The images 34 are analyzed, in particular by color score comparison. It is verified, if the correct assembly part 13 has been taken from the tray (correct part removal verification 37). The supply arrangement 21 controller sends a signal to the assembly management system 3 when the assembly part 13 has successfully been removed from the tray (report successful part removal 38).

After that, the assembly management system 3 can continue with the assembly process. The assembly management system 3 instructs the guide system 10 which projection 12 it shall project. Here it projects the projection 12 of the assembly part removed 36 from the supply tray 22 (guide system instruction 39).

In various embodiments, the guide system 10 loads the projection 12 to be projected and projects it on the structural component 2 (installation projection 40).

According to one embodiment, it is proposed that the guide system 10 projects the outline 41 of the assembly part 13 onto the structural component 2 at the position where it is to be installed. This guides the operator 8 not only on where to install the assembly part 13 but also with which orientation to install it.

After the installation of the assembly part 13 the operator 8 confirms the installation of it (installation confirmation 42).

According to one embodiment it is proposed that the operator 8 waves a reflective card 43 after installation of the assembly part 13. Here he waves the reflective card 43, in particular a retro-reflective card, between the projection 12 and the light projector 11. This is detected by the sensor 18. Upon this, the guide system 10 switches to a verification mode.

According to one embodiment it is proposed that a verification step 19 is performed and a section of the structural component 2, on which the assembly part 13 was installed, is scanned and compared to control data 44 (verification step 19). In particular, the verification step 19 is performed on detection of the waving of the reflective card 43 by the projector.

In various embodiments, the control data 44 is defined in the file 15 and/or transferred, in particular from the assembly management system 3, to the guide system 10 together with the projection data 14, in particular in one file 15.

Here the file 15 contains the projection data 14 for installation of the assembly parts 13 and the corresponding control data 44 for verification of the installed assembly parts 13.

According to one embodiment it is proposed that the guide system 10 reports to the assembly management system 3, whether the verification step 19 was successful or not (verification report 45).

The assembly management system 3 progresses to the next work instruction if the verification was successful (progress to next work instruction 46).

According to one embodiment it is proposed that the guide system 10 performs a scan of the structural component 2 and/or the structural component holder 6 in order to assess the orientation of the structural component 2 to the projector in an adjustment step, in some embodiments, that the guide system 10 performs a transformation of the projection data 14 based on the result of the adjustment step in order to align projection 12 and structural component 2. The same applies, in some embodiments, to the control data 44 for verification.

This allows to assess the relative position and orientation inaccuracy between the projector and the structural component 2 and to compensate those by transformation.

Another teaching which is of equal importance relates to an assembly system 1 for assembling a structural component 2, in particular an aircraft structural component 2, the assembly system 1 comprising an assembly management system 3 for the management of assembly tasks 5 in at least one assembly station 4, the at least one assembly station 4 comprising a structural component holder 6 for holding the structural component 2, in particular via a clamping frame 7, the assembly system 1, in particular the assembly station 4, comprises at least one guide system 10 comprising a light projector 11 for guiding an operator 8 via projections 12, the assembly system 1 designed for carrying out the method as described above.

This enables a simple and efficient way to guide the worker through the assembly tasks 5 end improve assembly time and quality. Additionally or alternatively, an efficient way to transfer the projection data 14 is provided in order to facilitate the guidance of the operator 8 end ensure simple transfer of the projection data 14 and quick response times of the guide systems 10.

All explanations given with regard to the method are fully applicable.

### REFERENCE NUMBERS

1 assembly system
2 structural component
3 assembly management system
4 assembly station
5 assembly tasks
6 structural component holder
7 clamping frame
8 operator
9 lifting platform
10 guide system
11 light projector
12 projection
13 assembly part
14 projection data
15 file
16 coordinates
17 pixels
18 sensor
19 verification step
20 instruction set
21 supply arrangement
22 supply tray
23 rivet
24 stringer
25 collar
26 supply control
27 optical sensor
28 vision sensor
29 photo eye sensor
30 supply projector
31 instruction for assembly part removal
32 marking step
33 crosshair
34 image
35 image acquisition
36 assembly part removal
37 correct part removal verification
38 report successful part removal
39 guide system instruction
40 installation projection
41 outline
42 installation confirmation
43 reflective card
44 control data
45 verification report
46 progress to next work instruction

1. A method for operating an assembly system for assembling a structural component,
the assembly system comprising an assembly management system for the management of assembly tasks in at least one assembly station,
the at least one assembly station comprising a structural component holder for holding the structural component,
the assembly system comprises at least one guide system comprising at least one light projector for guiding an operator via projections, wherein at least the projection data of at least two projections for different assembly steps is transferred to the guide system together and/or the projection data for at least one projection including shape and location information for that projection is transferred to the guide system together.

2. The method according to claim 1, wherein least the projection data of at least two projections for different assembly steps are transferred to the guide system together in one file and/or the projection data for at least one projection including shape and location information for that projection is transferred to the guide system together in one file.

3. The method according to claim 1, wherein the projection data of the majority projections for the assembly steps of one structural component are transferred to the guide system together.

4. The method according to claim 1, wherein the projection data has been transformed such that it takes the projection surface on which the projections are projected and/or the shape of the structural component after the assembly step to be supported by the projection into account.

5. The method according to claim 1, wherein the projection data of a projection defines the projection as a plurality of coordinates and/or pixels.

6. The method according to claim 1, wherein the guide system comprises a sensor for an adjustment step of the structural component and the guide system and/or for a verification step for verification of the assembly of an assembly part to the structural component.

7. The method according to claim 1, wherein the assembly management system generates an instruction set for guiding an operator, wherein the instruction set comprises a plurality of assembly tasks, and/or, that in the assembly management system the individual assembly tasks of an instruction set are linked to individual projections.

8. The method according to claim 1, wherein the assembly system comprises at least one supply arrangement for supplying assembly parts to the assembly station.

9. The method according to claim 8, wherein the supply arrangement comprises a supply control for operation of the supply arrangement and/or an optical sensor.

10. The method according to claim 1, wherein the guide system and/or a supply projector indicates the assembly part to pick for assembly with a projection onto the assembly part and/or the supply tray.

11. The method according to claim 9, wherein the optical sensor acquires an image of the supply tray prior the assembly part to be assembled is taken from it and after the assembly part to be assembled is taken from it.

12. The method according to claim 1, wherein the optical sensor detects the entering of the hand of an operator and/or the removal of a hand of an operator from the supply tray.

13. The method according to claim 1, wherein the guide system projects the outline of the assembly part onto the structural component on the position where it is to be installed.

14. The method according to claim 1, wherein the operator waves a reflective card after installation of the assembly part.

15. The method according to claim 1, wherein a verification step is performed and a section of the structural component, on which the assembly part was installed, is scanned and compared to control data.

16. The method according to claim 1, wherein the guide system reports to the assembly management system, whether the verification step was successful or not.

17. The method according to claim 1, wherein the guide system performs a scan of the structural component and/or the structural component holder in order to assess the orientation of the structural component to the projector in an adjustment step.

18. An assembly system for assembling a structural component,
the assembly system comprising an assembly management system for the management of assembly tasks in at least one assembly station,
the at least one assembly station comprising a structural component holder for holding the structural component,
the assembly system comprises at least one guide system comprising a light projector for guiding an operator via projections, the assembly system designed for carrying out the method of claim 1.

19. The method according to claim 8, wherein the supply arrangement comprises a supply tray carrying at least one assembly part.

20. The method according to claim 11, wherein the images are compared in order to analyze if the right part has been taken from the supply tray.
